(19) United States
(12) Patent Application Publication
(10) Pub. No.: US 2016/0371475 A1
(43) Pub. Date: Dec. 22, 2016

(54) ENHANCED ALTERNATIVE MULTIFACTOR AUTHENTICATION

(71) Applicant: Microsoft Technology Licensing, LLC, Redmond, WA (US)

(72) Inventors: Kaidi Zhao, Kirkland, WA (US); Stephen Dispensa, Mercer Island, WA (US)

(21) Appl. No.: 14/744,024

(22) Filed: Jun. 19, 2015

(51) Int. Cl. G06F 21/31; G06F 21/34; H04L 29/06; H04W 12/06

(52) U.S. Cl. CPC G06F 21/31; H04W 12/06; G06F 21/34; H04L 63/08

(57) ABSTRACT

Disclosed herein is a system and method for authenticating a user to a second device based on the user's current authentication to a primary device. Through a first device that the user is authenticated to the user can prove to the other devices that the user is proximate to the other devices that these devices can automatically authenticate the user based on the user's authentication with the first device. The devices either exchange information between them or record specific information about their surroundings that when the information or recordings match the user is authenticated to the other devices.

### BACKGROUND

Authentication of users and devices remains a persistent technical problem in the information technology industry. With the proliferation of untrusted applications and untrusted networks, and the increasing use of the Internet for business functions, these authentication issues have become prominent. Authentication refers to a process by which a user makes his or her identity known to a system or application which the user is attempting to access, and occasionally, also the process by which the user verifies the identity of the system being accessed. A common authentication technique involves the use of a shared username and password combination. This style of authentication is vulnerable to a number of weaknesses. For example, passwords must be made long enough to be secure while being short enough to be memorable. Additionally, the loss of the password is sufficient to allow an attacker to gain access to the system by impersonating the user.

Users often have more than one device that they use on a frequent basis. Each of these devices often requires the user to authenticate to the device before the device grants the user access. When the user presents the correct authentication credentials the user is granted access to the device. Often times these devices are linked to a common system where the user may be presenting the same credentials (user name and password), and as such the presentation of the credentials may seem redundant. However, to ensure that each device remains secure the reentry of the credentials is required to access each device.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for authenticating a user to a second device based on the user's current authentication to a primary device. Typically, the user has a mobile device that they are authenticated into. Through this device the user can prove to the other devices that the user is proximate (or close enough) to the other devices that these devices can automatically authenticate the user based on the user's authentication with the first device. This can be accomplished through a number of different methods and processes. For example the ambient sound recorded by the devices can be compared and if they match the user can be authenticated to the other devices. One device can transmit a sound or display an image or pattern that has a digital signature in it. This signature can be recorded or captured by the other device. If both devices report back with the same image or signature then access can be granted. In other approaches the user may be asked to capture an image using a camera feature on their device, this will be compared with other publically available images to verify the user is at the location they claim to be at. Again authentication can be given based on a match between images.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic illustration of a networked computing environment according to one illustrative embodiment.

FIG. 2 is a schematic illustration of an exemplary computer system according to one illustrative embodiment.

FIG. 3 is a schematic illustration of a networked computing environment according to one illustrative embodiment.

FIG. 4 is a flow diagram of one method for multifactor authentication according to one illustrative embodiment.

FIG. 5 is a flow diagram illustrating a process for authenticating a user with a device based on the user's authentication with another device according to one illustrative embodiment.

FIG. 6 is a flow diagram illustrating a process for recording and authentication based on ambient sound.

FIG. 7 is a flow diagram illustrating a process for transmitting from one device and recording at a second device as part of the authentication process.

FIG. 8 is a flow diagram of active participation by the user in the authentication process.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media, but not with computer storage media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

The present disclosure utilizes product architecture, business requirements and telemetry to create and deploy cloud or other distributed services. Currently developers rely on PoCs and manual configurations to create and deploy cloud services to meet their business needs. This process is time intensive and error prone. The present disclosure takes an architecture to the cloud by automating cloud service creation and deployment as per architecture artifacts like UML diagrams. This allows the architect to design the system including the desired operational requirements of the system and no longer concern themselves with the actual construction and configuration of the distributed system that is needed to make the service happen.

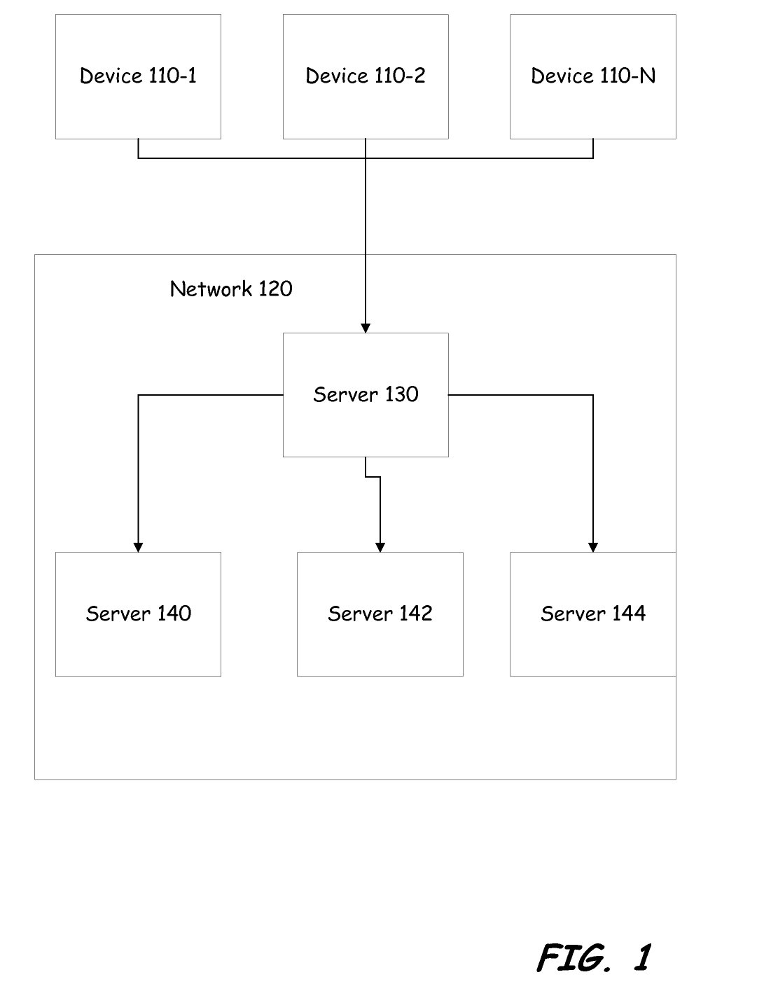

FIG. 1 is a schematic illustration of a networked computing environment in accordance with an embodiment. In the exemplary architecture depicted in FIG. 1, one or more client computing devices 110-1, 110-2, 110-N establish a communication connection with server, such as a point of presence (POP) server 130, which in turn communicates with one or more target servers 140, 142, 144 via a network 120. Target servers 140, 142, 144, in turn, provide access to one or more computing resources such, as, e.g., internet services, electronic mail services, data transfer services, and the like.

Client computing devices 110-1, 110-2, 110-N may be any computer-based communication device, including a personal computer 110-1, a personal digital assistant (PDA) 110-2, or a terminal device 110-N. Client computing devices 110-1, 110-2, 110-N establish a communication with POP server 130 via a communication network, which may be the same network 120 or a separate communication network. The communications network may be any type of network through which two devices can connect. Communication network may be one or more direct communication links (e.g., a dial-up connection) between respective remote access devices 110-1, 110-2, 110-N. Alternatively, the communication network may be a private data network such as, e.g., an X.25 network, a local area network (LAN), a wide area network (WAN), or a public network such as, e.g., the Internet.

In one embodiment, POP server 130 may be implemented by a general purpose computing device such as, e.g., a server, that executes logic instructions which cause the processor to execute various methods for performing secure network computing.

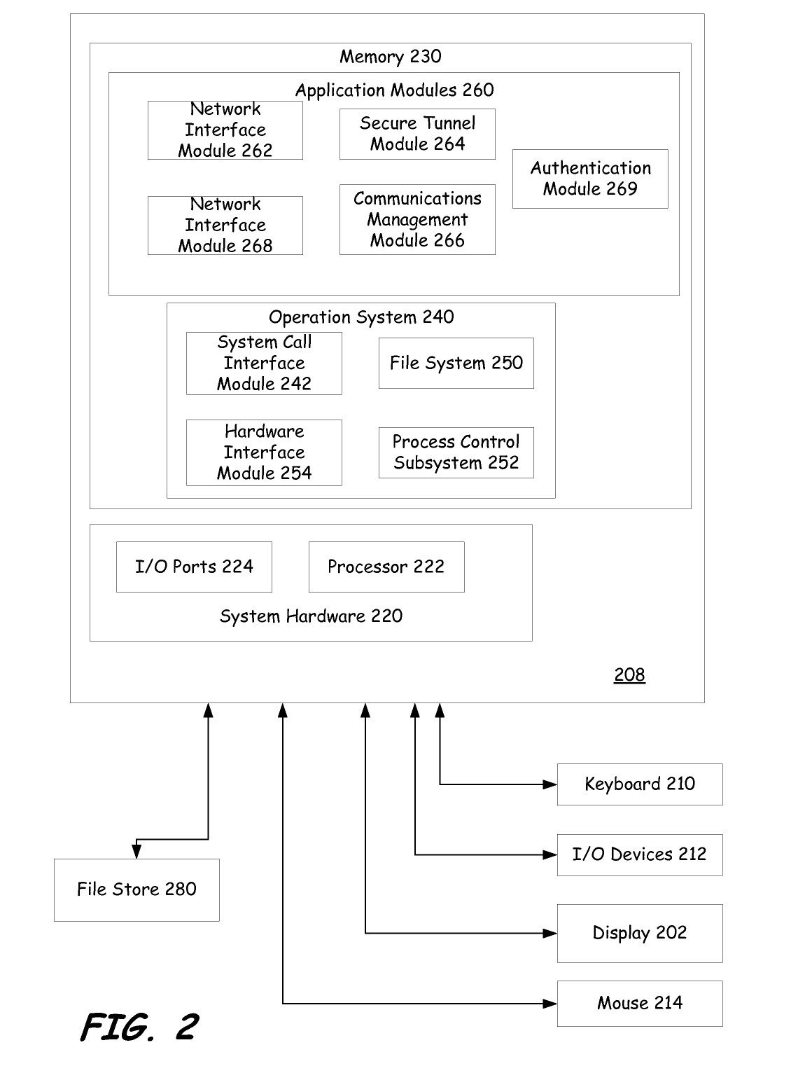

FIG. 2 is a schematic illustration of an exemplary computer system 200 adapted to perform secure network computing. The computer system 200 includes a computer 208 and one or more accompanying input/output devices including a display 202, a keyboard 210, other I/O device(s) 212, and/or a mouse 214. The other device(s) 212 can include a touch screen, a voice-activated input device, a track ball, and any other device that allows the system 200 to receive input from a developer and/or a user. The computer 208 includes system hardware 220 and random access memory and/or read-only memory 230. A file store 280 is communicatively connected to computer 208. System hardware 220 includes a processor 222 and one or more input/output (I/O) ports 224. File store 280 may be internal such as, e.g., one or more hard drives, or external such as, e.g., one or more external hard drives, network attached storage, or a separate storage network.

Memory 230 includes an operating system 240 for managing operations of computer 208. In one embodiment, operating system 240 includes a hardware interface module 254 that provides an interface to system hardware 220. In addition, operating system 240 includes one or more file systems 250 that managed files used in the operation of computer 208 and a process control subsystem 252 that manages processes executing on computer 208. Operating system 240 further includes a system call interface module 242 that provides an interface between the operating system 240 and one or more application modules 262 and/or libraries 264.

In operation, one or more application modules 260 executing on computer 208 make calls to the system call interface module 242 to execute one or more commands on the computer's processor. The system call interface module 242 invokes the services of the file systems 250 to manage the files required by the command(s) and the process control subsystem 252 to manage the process required by the command(s). The file system 250 and the process control subsystem 252, in turn, invoke the services of the hardware interface module 254 to interface with the system hardware 220.

The particular embodiment of operating system 240 is not critical to the subject matter described herein. Operating system 240 may be embodied as, for example, a UNIX operating system or any derivative thereof (e.g., Linux, Solaris, etc.), as a Windows operating system by Microsoft Corporation, as an iOS operating system by Apple Corporation, Chrome OS by Google, or any other operating system.

In one embodiment, memory 230 includes one or more network interface modules 262, 268, one or more secure tunnel modules 264, and one or more communication management modules 266. Network interface modules may be implemented as web browsers such as, e.g., Internet Explorer, Netscape, Mozilla, or the like. Secure tunnel module 264 comprises logic instructions which, when executed by a processor, configure the processor to generate a secure communication tunnel between the POP server 130 and a client computing device such as, e.g., one or more of client computing devices 110-1, 110-2, 110-N. Communication management module 266 comprises logic instructions which, when executed by a process, configure the processor to manage communications between the POP server 130 and one or more client computing devices 110-1, 110-2, 110-N and between the POP server 130 and the one or more servers 140, 142, 144.

In embodiments, POP server 130 receives a service request from a client computing device such as, e.g., one or more of client computing devices 110-1, 110-2, 110-N, identifying one or more resources available on a server such as 140, 142, 144. For example, the service request may be embodied as a Uniform Resource Locator (URL) transmitted to POP server 130 from a browser executing on a client computing device. In response to the service request, POP server 130 establishes a first communication link between the POP server 130 and the one or more resources available via a computing network identified in the service request. In one embodiment, POP server 130 may launch an independent request for the resource request for the resource identified in the service request from the client computing device. POP server 130 may further establish a first, secure communication link between the POP server 130 and the client computing device 110-1, 110-2, 110-N, and connect a network interface module on the client computing device to the secure communication link.

POP server 130 may further manage communication activity between the client computing device and the one or more resources available via a computing network at the POP server. In one embodiment, managing communication activity may include passing information received from a server 140, 142, 144 in response to a resource request from the POP server 130 to a client computing device 110-1, 110-2, 110-N via a secure communication link.

Described herein are multifactor authentication techniques which may be used alone, or in combination with other security techniques described herein to provide secure access to resources in a computer network. Embodiments of multifactor authentication techniques will be described in the context of a computer network similar to the network described in with reference to FIG. 1. It will be understood, however, that authentication techniques as described herein may be implemented in a wide variety of computer networks. Additionally, further described herein is a method and system for providing automatic authentication of a user based on the user's proximity to other devices.

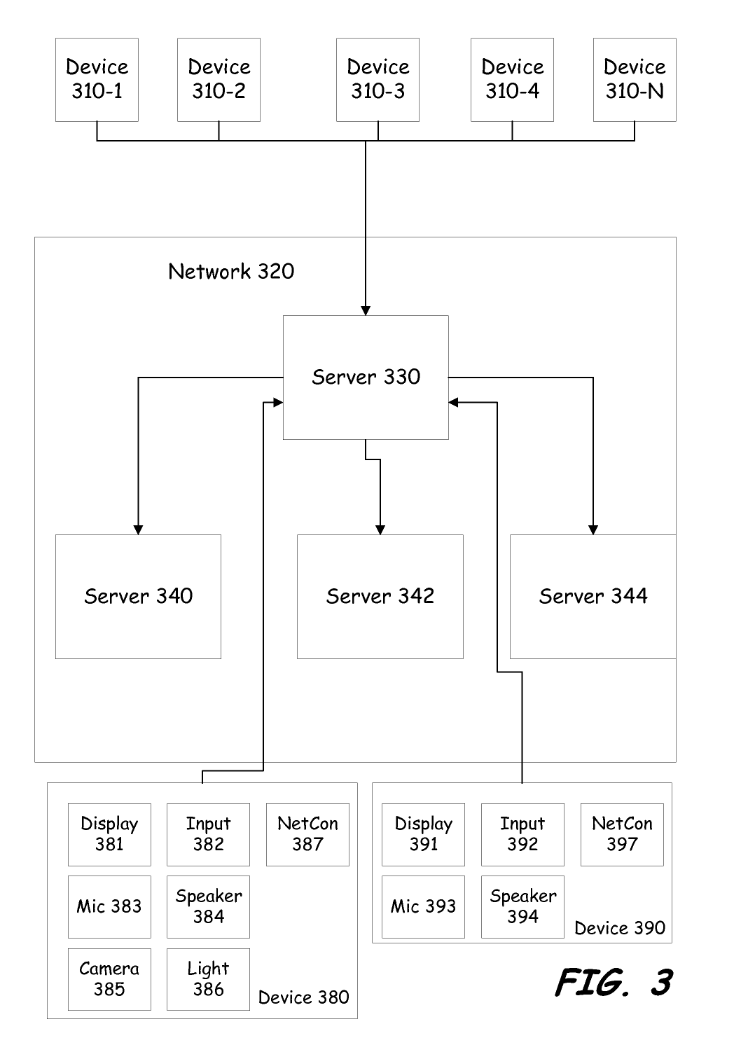

FIG. 3 is a schematic illustration of a networked computing environment in accordance with an embodiment. In the exemplary architecture depicted in FIG. 3, one or more client computing devices 310-1, 310-2, 310-3, 310-4, 310-N establish a communication connection with an authentication server 330, which in turn communicates with one or more target servers 340, 342, 344 via a network 320. Target servers 340, 342, 344, in turn, provide access to one or more computing resources such, as, e.g., internet services, electronic mail services, data transfer services, and the like.

Client computing devices 310-1, 310-2, 310-3, 310-4, 310-N may be any computer-based communication device, including for example a personal computer, a personal digital assistant (PDA), a terminal device, a mobile telephone, or other devices. Client computing devices 310-1, 310-2, 310-3, 310-4, 310-N establish a communication with authentication server 330 via a communication network, which may be the same network 320 or a separate communication network. The communications network may be any type of network through which two devices can connect. For example, communication network may be one or more direct communication links (e.g., a dial-up connection) between respective remote access devices 310-1, 310-2, 310-3, 310-4, 310-N. Alternatively, the communication network may be a private data network such as, e.g., an X.25 network, a local area network (LAN), a wide area network (WAN), or a public network such as, e.g., the Internet.

For purposes of this discussion, the discussion will continue with respect to a first computing device 380 and a second computing device 390.

The first computing device 380 can be any type of client computing device. For example the first computing device 380 can be a mobile phone, a tablet computer, a personal computer, a gaming system, a laptop computer or any other device that can be secured from unauthorized access by individuals who are not entitled to access the content on the computing device or accessible through the computing device. First computing device includes at least a display device 381, an input mechanism 382, a microphone 383, a speaker 384, a camera 385, a light 386, and a network connection 387.

The second computing device 390 is similar to the first computing device 380 and can be any type of client computing device. For example the second computing device 390 can be a mobile phone, a tablet computer, a personal computer, a gaming system, a laptop computer or any other device that can be secured from unauthorized access by individuals who are not entitled to access the content on the computing device or accessible through the computing device. Second computing device includes at least a display device 391, an input mechanism 392, a microphone 393, a speaker 394 and a network connection 397. For purposes of this disclosure it will be assumed that the first computing device 380 is a mobile computing device such as a mobile phone that the user can carry with them throughout the day and that can be easily separated from the second computing device 390 as the user moves throughout the day. The second computing device 390 for purposes of this discussion will be assumed to be a personal computer that is attached or otherwise non-movable within a room in a building. However, it should be noted that the disclosure contained herein with respect to the authentication of devices will work across all types of devices.

Authentication server 330 may be embodied as a computing device, substantially as described in with reference to FIG. 2, above. The authentication server can implement an authentication service. For purposes of this discussion the authentication server and authentication service are used interchangeably. It should be noted that the authentication service can be implemented on one or many of the computing devices 310-1, 310-2, 310-3, 310-4, 310-N, or may implemented on a remote device to which the computing devices connect or communicate with. Referring briefly back to FIG. 2, the computing device 200 and comprise one or more authentication modules 263 which may execute when as an application module and the memory 230 of the computing system 200. In some embodiments, the authentication module 263 and implemented logic instructions which, when executed by a processor such as the processor 222, cause the authentication module 263 to implement multifactor authentication procedures to manage access to one or more resources of the computer network 320, such as for example, resources provided by servers 340, 342, or 344.

The following is a description of a process for the authentication of a device in a first instance. This authentication can be done on any of the computing devices at any time depending on the settings that have been provided by an administrator or user. The process discussed herein is a multi-factor authentication process. This process ensures that the authenticated device should actually be authenticated for the particular purpose. In some embodiments, the authentication server 330 implements a first authentication process in response to an authentication request from a client computing device such as one of client computing devices 310-1, 310-2, 310-3, 310-4, 310-N. If the first authentication process is successful, then the authentication server 330 originates a second authentication request to a client device such as one of client computing devices 310-1, 310-2, 310-3, 310-4, 310-N. In some embodiments, the authentication request from the client is transmitted through a first communication channel and the second authentication request originated by the authentication server 330 is transmitted using a second communication channel, different from the first communication channel. The authentication server 330 may process the response to the second authentication request and allow or deny access to a resource based on the response. In some embodiments the first communication channel and the second communication channel may be across separate communication networks. For example, the first communication channel may be across the computer network, while the second communication channel may be across a telephone network.

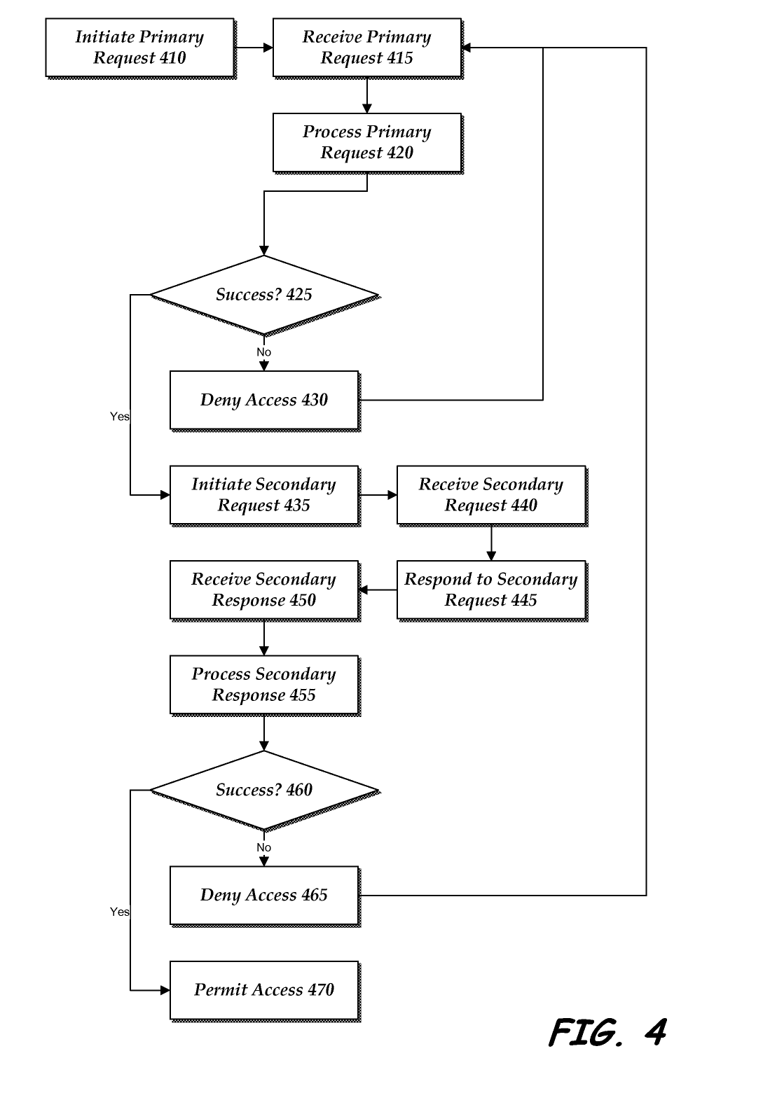

One embodiment of a multifactor authentication will be explained with reference to FIG. 4, which is a flow diagram of an exemplary method for multifactor authentication. Referring to FIG. 4, at step 410a first client initiates a primary authentication request for access to a resource provided by computer network 320. In some embodiments, the primary authentication request may include a username and password combination associated with a user and/or a device from which the primary authentication request is originated. The primary authentication request may be transmitted to the authentication server 330 to a first communication channel.

At step 415 the authentication server 330 receives the primary authentication request, and at step 420 the authentication server 330 processes the primary authentication request. In some embodiments, the authentication server 330 performs a centralized authentication function which manages authentication to one or more resources and network 320. For example, authentication server 330 may maintain a data file comprising username and password combinations which may be associated with one or more resources of the computer network 320.

If, at step 425, the primary authentication request is unsuccessful, i.e., if there is no corresponding username and password combination in a data table or other resource, then the authentication server 330 denies the requestor access to network resource(s). In some embodiments, the authentication server 330 may transmit an error message to the requestor indicating that the username and password are invalid. Control that returns to step 415 and the authentication server 330 continues to monitor for another primary authentication request. In some approaches this error is not reported back to the user. In this way the user will go through the multifactor authentication processes normally, but will not know why they failed the process. This helps the system remain more secure as brute force attackers will not be aware of a successful primary authentication simply by being presented with the secondary authentication.

By contrast, if at step 425 primary authentication request is successful, i.e., if there is a corresponding username and password combination in the data table or other resource, then control passes to step 435 and the authentication server 330 initiates a secondary authentication request. Again in cases where the failure of the primary authentication is not reported back to the user control is also passed to step 435. The secondary authentication request is transmitted from the authentication server 330 to the user via a second communication channel, different from the first communication channel. In some embodiments, the secondary authentication request is transmitted from the authentication server 330 to a second client in the user's possession. For example, the user may initiate the primary authentication request from a computing device such as a desktop computer or laptop computer and the authentication server 330 may transmit the secondary authentication request by initiating a telephone call to a telephone registered to the user.

At step 440 the secondary authentication request is received at the second client. The secondary authentication request may comprise a voice message which makes a request for information to authenticate the user. In some embodiments, the system may allow a user to prerecord a customized secondary authentication request in the user's own voice. For example, the user may record a message requesting a specific sequence of keystrokes or requesting the user to speak to a specific word or group of words. Having a user recorded message in the second authentication request helps to authenticate the system to the user, thereby eliminating or at least reducing the likelihood of a “man in the middle” attack on the system. In alternate embodiments, rather than using a prerecorded message in the user's voice, a user may select one or more tokens to be presented with a secondary authentication requests. For example, a token may include a predetermined word or character or numeric sequence selected by the user.

At step 445 the user response to the secondary authentication request initiated by the authentication server 330. For example, in some embodiments the user may respond by pressing a predetermined sequence of keystrokes on a telephone keypad, or by pressing the pound key or the star key. In alternate embodiments the user may respond by speaking a predetermined word or series of words. In alternate embodiments the user need not provide an affirmative response; simply answering the telephone call may suffice as a response.

In some embodiments, the secondary authentication request initiated by the authentication server 330 may be implemented as a text message rather than a telephone call. Accordingly, the response to the secondary authentication request may also be implemented as a text message in which the user transmits a predetermined character or series of characters back to the authentication server 330.

In alternate embodiments, the secondary authentication request may require a user to initiate a call back in order to authenticate the user. For example, the secondary authentication request may transmit a text message or a voice call requesting the user to call back to the system to authenticate the user. In some embodiments, a return phone number may be included with the secondary authentication request, while in other embodiments a user may be required to call a predetermined phone number. As described above, the user may be required to provide one or more codes in the secondary authentication response.

At step 450 the authentication server 330 receives the response to the secondary authentication request, and at step 455 the authentication server 330 processes the response. In some embodiments, authentication server 330 maintains authentication codes which represent the anticipated response to the secondary authentication request in the data table. The response to the secondary authentication request received from the user may be compared with the authentication code stored in the data table in order to determine whether the user is authentic.

If, at step 460, the response to the secondary authentication request fails to successfully authenticate the user then access to network resources is denied at step 465 and control passes back to step 415 in the authentication server 330 monitors for additional incoming primary authentication requests. In some embodiments, the authentication server 330 may implement an error routine in response to a failed a secondary authentication request. The authentication routine may transmit an error message to the user via the first communication channel, the second communication channel, or both. The error message may instruct the user that authentication has failed and they provide the user with an opportunity to restart the authentication process.

By contrast, is at step 460 the response to the secondary authentication request successfully authenticates the user then control passes to step 470 and the user is granted access to the network resource or resources associated with the username and password in the data table 1100. Control then passes back to step 415 and the authentication server 330 continues to monitor for additional primary authentication request.

Thus, the operations depicted in FIG. 4 enable the network infrastructure depicted in FIG. 3 to implement a multifactor authentication process. In some embodiments described herein, the multifactor authentication process utilizes two separate network devices, i.e., a computing device and a telephone. In some embodiments, the multifactor authentication process may utilize a single network device, i.e., a computing device, which executes two or more logical network devices. For example, a user may initiate a primary authentication request from a first application executing on the computing device, and the second authentication request may be directed to a second application executing on the computing device. For example, the second application may be an Internet Protocol (IP) telephony application.

Various features may be added to the functionality of the basic authentication process described herein. In some embodiments, the authentication server 330 may store in a memory module such as cache memory the results of a primary authentication request initiated by a user, alone or in combination with the results of a secondary authentication response provided by the user. The results may be stored in for a predetermined period of time or for a dynamic period of time. Thus, when a user has successfully authenticated himself or herself to the system additional authentication may not be required during the time period. The authentication server 330 may require that subsequent primary authentication requests be initiated from the same network address in order to bypass the secondary authentication request. Thus, in some embodiments the authentication server 330 may detect the network address from which the primary authentication request is initiated and may store the network address in a memory module.

Further, there may be circumstances in which secondary authentication requests may not be necessary. For example, if a user is located on a trusted network in the secondary authentication request may be bypassed. Thus, in some embodiments of the authentication server 330 may detect the network address from which the primary authentication request is initiated and may compare the network address with a list of approved network addresses stored in a memory module.

Still further, there may be circumstances in which the authentication server 330 declines to initiate a secondary authentication requests. In some embodiments, in the event of a predetermined number of failures for a primary authentication request the authentication server 330 may flag a user as a suspect for fraudulent access and may decline to initiate a secondary authentication request unless further conditions are met. In some embodiments, in the event multiple primary authentication requests are received from different network addresses within a predetermined period of time the authentication server 330 may flag a user as a suspect for fraudulent access and may decline to initiate a secondary authentication request unless further conditions are met. For example, a user may be required to reset passwords or to speak personally with an administrator.

In some embodiments, the authentication server 330 may provide a user interface that enables users to register one or more telephone numbers or contact addresses for the network device intended for use for the secondary authentication request. The user interface may further permit users to select one or more authentication codes or personal identification numbers (PINs) for both the primary authentication request and the secondary authentication response.

Various alternate embodiments may be implemented. For example, in some situations it may not be possible to submit a user's primary authentication credentials to the authentication server 330 without incurring unwanted side-effects. For example, logging into a web application using primary authentication credentials may cause the application to take actions such as creating a user session, logging a message, or the like that may be undesirable.

In such situations, the authentication server 330 may implement a pre-authentication process. After receiving the primary authentication credentials, the authentication system can attempt to pre-authenticate them using a different API interface, rather than pre-authenticating to the target server itself. For example, in a web application such as Microsoft's Outlook Web Access, the system may pre-authenticate the user by calling the Windows LogonUser( ) API, which checks the user's username and password against the Windows password database. Alternatively, in a Citrix environment, the system could pre-authenticate the user using the Citrix authentication APIs.

If the pre-authentication step is successful, the secondary authentication may be implemented as described before. Only if that is also successful are the user's credentials submitted to the application in question for final log-in. This becomes a three-phase login, but it has the benefit of allowing compatibility with applications that would not otherwise support the two-phase approach.

In addition, the strength of the authentication process can be increased using voice-print technology during the confirmation call. During the secondary authentication call, the system asks the user to repeat a series of words. The user repeats the words, and the system makes a determination of whether the user is who he claims to be by evaluating the user's voice against a voice database, using voice matching algorithms.

Again, this makes the system three-factor: the primary authentication is something the user knows, the secondary is something the user has (phone), and the tertiary authentication is something the user is (his voice).

This system can also be used for multi-person authentication. For example, in situations which require the approval of more than one to allow an action to complete, multiple secondary authentication calls can be placed. For example, in the case of a bank transfer requiring two people to agree to the transaction, the system may place multiple confirmation calls, one to every person authorized to approve the transaction. It could then play back details of the proposed transaction to each user (which can happen simultaneously), and if a minimum number of those users confirm the transaction, the system returns success. This system can scale to an arbitrarily large number of required confirmations.

Referring back to FIG. 4 and the associated discussion, the user has now authenticated the first computing device 380 with the authentication server 330 through the authentication service.

The first computing device 380 and the second computing device 390s are configured to allow for audio authentication of the user with the computing devices. Once the user has been authenticated with the authentication service each of the computing devices is now open to allowing for the authentication of the user with the devices through the use of sound. This authentication goes to all the devices that are considered by the authentication service to be authenticatable together. Thus, a user can authenticate to more than one device at the same time.

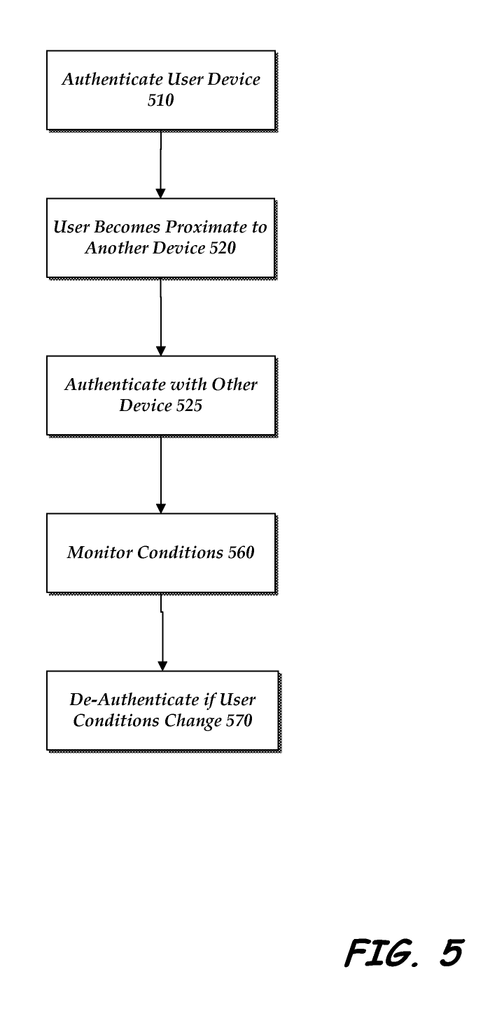

FIG. 5 is a flow diagram illustrating a process for authenticating a user with a device based on the user's authentication with another device. As discussed above, the user first authenticates at least one of their devices through the normal authentication process. This is illustrated at step 510. This authentication process can be any authentication process that is implemented by the user's organization to authenticate a device. In one approach this is the multifactor authentication method discussed above. The multifactor authentication method above provides added benefits in the use of an audio based authentication system in that there is a greater degree of security in that the computing device is actually associated with the correct user and has not otherwise been compromised. However, any form of authentication of the first computing device 380 may be used. While the present discussion uses the terms first computing device 380 and second computing device 390 in terms of the authentication processes, these are simply provided as terms of convenience. It should be noted that the processes can be performed by any of the devices with that device acting as the first computing device 380.

Once the first computing device 380 has been authenticated the user is now capable of authenticating to the other computing devices without doing anything more. The next step in the authentication process is for the user with the first computing device 380 to become proximate to the second computing device 390. This is illustrated at step 520. The proximity of the user to the second computing device 390 can vary, but the proximity should be close enough that both the first computing device 380 and the second computing device 390 can both hear the same sounds. For example, both computing devices are in the same room.

Now that the first computing device 380 and the second computing device 390 are proximate to each other the first computing device 380 and the second computing device 390 begin the authentication process. This is illustrated at step 525. The authentication process envisioned herein can take one of at least three paths. These paths can be performed singly or can be performed as a combination. That is the authentication process may require that the user/computing device perform two or more of the authentication paths.

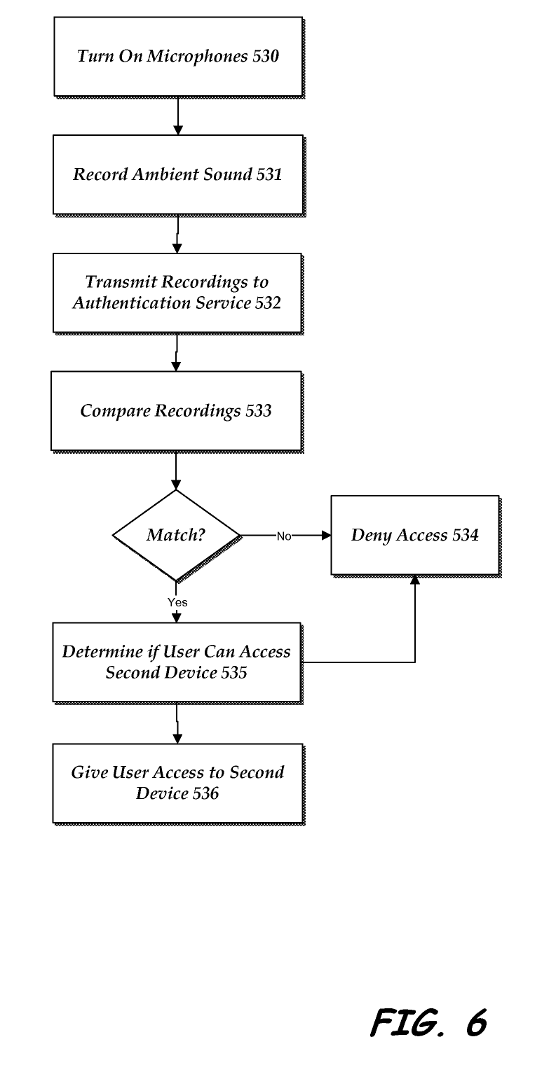

The first authentication path is illustrated by the process of FIG. 6. The first authentication path is an entirely passive path where the user does not do anything at all to authenticate to the other computing devices. The first step of the process is that the first computing device 380 and the second computing device 390 both turn on their associated microphones. This is illustrated at step 530. Next, both the first computing device 380 and the second computing device 390 record the ambient sounds that they are currently hearing through their microphones. This is illustrated at step 531. This recording of the sound may also include a timestamp to allow for the correspondence of the two or more recordings with each other.

Next the first computing device 380 and the second computing device 390 transmit the recorded ambient sound to the authentication service. This is illustrated at 532. Also at this step, information about each of the devices may also be sent to the authentication service. This information can include information related to the machine that is transmitting the recording, the machines location, information about the location of the machines (such as room shape, acoustic variances known in the room, etc.), and/or the machines trusted platform module (TPM) verifying the identity of the machine.

The authentication service receives this information from the first computing device 380 and the second computing device 390 and compares the recordings. This is illustrated at step 533. At this step the authentication service compares the recording from the first computing device 380 with the recording from the second computing device 390 and determines if both devices recorded the same ambient sound. In this process the authentication service aligns the timestamps of the two recordings with each other to ensure that the same time recordings are being compared. In some approaches the authentication service can adjust the time stamps of one or more of the computing devices based on the received time stamps. For example if the internal clock of one of the devices differs from any of the other devices the time stamps will not align. The authentication service can use the difference between the reported clock times to adjust the timestamp for one of the recordings such that a comparison can be made. However, if multiple devices are reporting significantly different clock times the authentication service may not adjust the recordings. The authentication service may also adjust the analysis of the sounds recorded by the devices to account for various differences in the room dynamics. For example, if the room is an odd shape then the recording from one device may have some variances in the recording that when adjusted for based on the room dynamics and acoustics allows for the sound to be the same.

If the two recordings are determined to be recording of the same ambient sound the authentication service considers them to be a match. If they are a match the process continues to step 535. If they are not a match the authentication service does not authenticate the user to the other computing devices at step 534.

Referring to step 535, the authentication service proceeds to verify the current credentials of the first computing device 380. At this step the authentication service identifies the user associated with the first computing device 380 and also identifies other computing devices and services that the user is authorized to access. The authentication service determines at this step whether the user is authorized to access the second computing device 390 and at what level of access. If the user is not permitted to access the second computing device 390 the authentication service denies the access at step 534. If the user is permitted to access the second computing device 390, the authentication service authenticates the user to the second computing device 390 at step 536. At this step the authentication service can send a message to the second computing device 390 that contains the credentials for the user such that the second computing device 390 can “log” the user into the device. Alternatively, the authentication service can simply cause the second computing device 390 to become active with the user's credentials already applied to the device. After this step the user may interact with the computing device as normal. In some embodiments if there are multiple other devices that are known to be in the vicinity of the second computing device 390 that also require authentication the present process can authenticate the user to those devices as well, either based on the authentication with the second computing device or by repeating the process herein for that device.

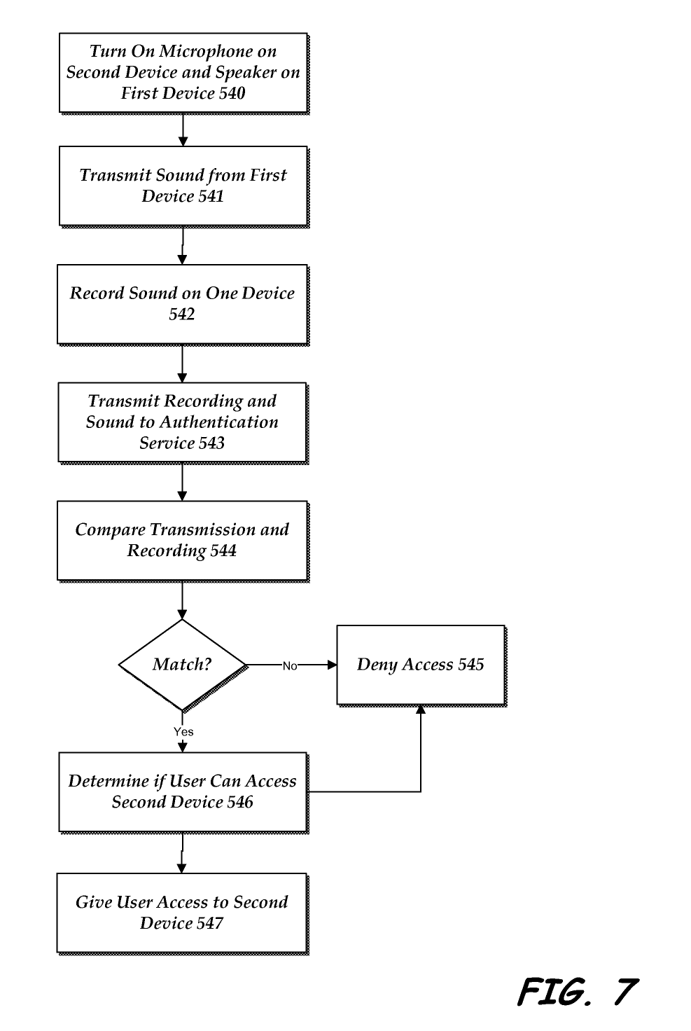

The second authentication path is illustrated by the process of FIG. 7. The second authentication path can be an entirely passive path where the user does nothing, or it may be an active path where the user initiates the process. The first step of the process is that speaker of the first computing device 380 is turned on and the microphone of the second computing device 390 is turned on. This is illustrated at step 540. This process allows for the first computing device 380 to transmit a sound or sounds to the second computing device 390 which will receive the sounds. It should be noted that the microphone/speaker roles can be reversed.

Next the first computing device 380 transmits music or another sound that contains a digital fingerprint. This is illustrated at step 541. The transmission of the music may occur without intervention from the user or the user may interact with the device to cause the sound to be transmitted. The sound that is transmitted need not be audible to the user or a human. For example, the sound may be ultrasonic. The second computing device 390 records the sound that was played by the first computing device 380. This is illustrated at step 542. This recording of the sound may also include a timestamp to allow for the correspondence of the two or more recordings with each other.

Next the first computing device 380 transmits the sound that was played to the room along with an associated timestamp for the transmission of sound and the second computing device 390 transmits the recorded sounds to the authentication service. This is illustrated at 543. Also at this step, information about each of the devices may also be sent to the authentication service. This information can include information related to the machine that is transmitting the recording, the machines location, information about the location of the machines (such as room shape, acoustic variances known in the room, etc.), and/or the machines trusted platform module (TPM) verifying the identity of the machine.

The authentication service receives the recording and the transmission from the computing devices and then compares the two transmissions. This is illustrated at step 544. At this step the authentication service compares the transmission from the first computing device 380 with the recording from the second computing device 390 and determines if the second computing device 390 recorded the transmission from the first computing device 380 by looking for the corresponding digital signature from the transmission in the recording. In this process the authentication service aligns the timestamps with each other to ensure that the same time is being compared. In some approaches the authentication service can adjust the time stamps of one or more of the computing devices based on the received time stamps. For example if the internal clock of one of the devices differs from any of the other devices the time stamps will not align. The authentication service can use the difference between the reported clock times to adjust the timestamp for one of the recordings such that a comparison can be made.

If the recording is determined to be a recording of the transmission the authentication service considers them to be a match. If they are a match the process continues to step 546. If they are not a match the authentication service does not authenticate the user to the other computing devices at step 545. Referring to step 546, the authentication service proceeds to verify the current credentials of the first computing device 380. At this step the authentication service identifies the user associated with the first computing device 380 and also identifies other computing devices and services that the user is authorized to access. The authentication service determines at this step whether the user is authorized to access the second computing device 390 and at what level of access. If the user is not permitted to access the second computing device 390 the authentication service denies the access at step 545. If the user is permitted to access the second computing device 390, the authentication service authenticates the user to the second computing device 390 at step 547. At this step the authentication service can send a message to the second computing device 390 that contains the credentials for the user such that the second computing device 390 can “log” the user into the device. Alternatively, the authentication service can simply cause the second computing device 390 to become active with the user's credentials already applied to the device. After this step the user may interact with the computing device as normal. After this step the user may interact with the computing device as normal. In some embodiments if there are multiple other devices that are known to be in the vicinity of the second computing device 390 that also require authentication the present process can authenticate the user to those devices as well, either based on the authentication with the second computing device or by repeating the process herein for that device.

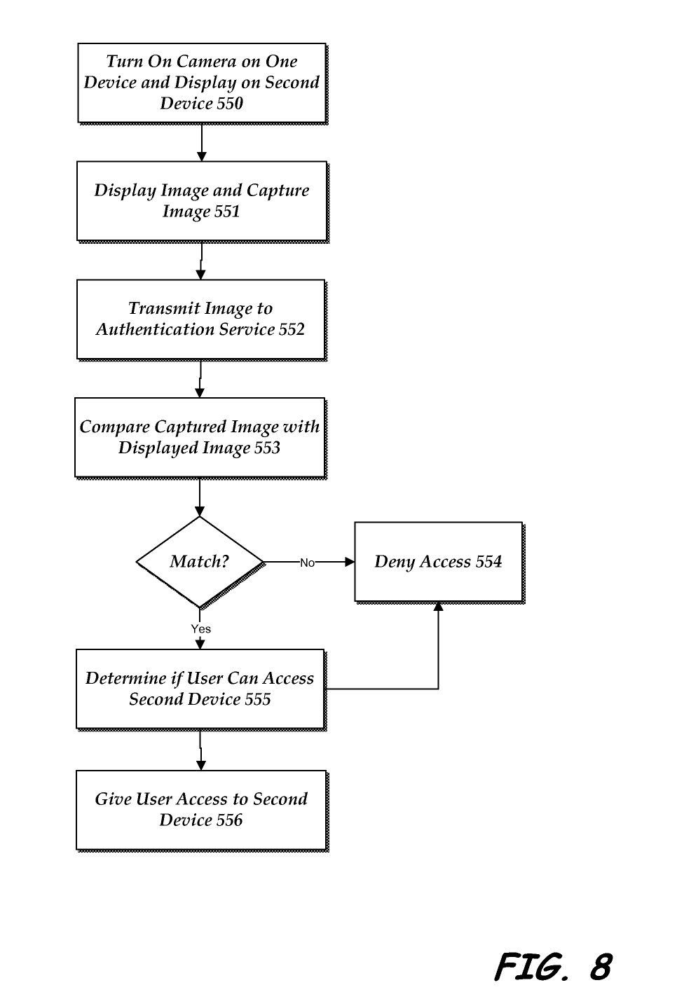

The third authentication path is illustrated by the process of FIG. 8. The third authentication path is an active path whereby the user has to actively participate in the authentication process. This authentication path relies on the comparison of an image displayed by one device and captured by another device to authenticate the user. The first step in this process is that one of the computing devices turns on its camera function and the other device activates its display device. This is illustrated at step 550. For purposes of this discussion it will be presumed that the first computing device 380 turns on its camera and the second computing device 390 turned on its display device. Next the second computing device 390 displays an image on its display device and the first computing device 380 records the displayed image through its camera. This is illustrated at step 551. The image that is displayed can be a static image or it may be a moving image. Contained in the image is a digital fingerprint that can be used to authenticate the image. This digital fingerprint does not need to be visible or noticeable to the user. If the image is a moving image a timestamp of the image may also be recorded. In some approaches instead of using an image the light feature of, for example the flash of a mobile phone, the device can be used instead of the screen. The light that is displayed can be outside the range detectable by the human eye.

Next the first computing device 380 transmits the recorded image and any associated timestamp and the second computing device 390 transmits the displayed image/images to the authentication service. This is illustrated at 552. Also at this step, information about each of the devices may also be sent to the authentication service. This information can include information related to the machine that is transmitting the image, the machines location, information about the location of the machines, and/or the machines trusted platform module (TPM) verifying the identity of the machine.

The authentication service receives the recording and the transmission from the computing devices and then compares the two transmissions. This is illustrated at step 553. At this step the authentication service compares the transmission from the second computing device 390 with the recording from the first computing device 380 and determines if the first computing device 380 recorded the transmission from the second computing device 390 by looking for the corresponding digital fingerprint from the transmission in the recording. In this process the authentication service aligns the timestamps (if necessary) with each other to ensure that the same time is being compared. Again in some approaches the authentication service can adjust the time stamps of one or more of the computing devices based on the received time stamps. For example if the internal clock of one of the devices differs from any of the other devices the time stamps will not align. The authentication service can use the difference between the reported clock times to adjust the timestamp for one of the recordings such that a comparison can be made.

If the recording is determined to be a recording of the transmission the authentication service considers them to be a match. If they are a match the process continues to step 555. If they are not a match the authentication service does not authenticate the user to the other computing devices at step 554. Referring to step 555, the authentication service proceeds to verify the current credentials of the first computing device 380. At this step the authentication service identifies the user associated with the first computing device 380 and also identifies other computing devices and services that the user is authorized to access. The authentication service determines at this step whether the user is authorized to access the second computing device 390 and at what level of access. If the user is not permitted to access the second computing device 390 the authentication service denies the access at step 554. If the user is permitted to access the second computing device 390, the authentication service authenticates the user to the second computing device 390 at step 556. At this step the authentication service can send a message to the second computing device 390 that contains the credentials for the user such that the second computing device 390 can “log” the user into the device. Alternatively, the authentication service can simply cause the second computing device 390 to become active with the user's credentials already applied to the device. After this step the user may interact with the computing device as normal. After this step the user may interact with the computing device as normal. In some embodiments if there are multiple other devices that are known to be in the vicinity of the second computing device 390 that also require authentication the present process can authenticate the user to those devices as well, either based on the authentication with the second computing device or by repeating the process herein for that device.

While the present discussion has discussed three different authentication paths 501, 502 and 503 for the authentication of the users it should be noted that other data can be used to authenticate the user with the system. For example, publically available media can be used and compared with media captured by the first computing device 380. For example the user takes a picture of a street and this image is compared with public webcams at that area. This information can be analyzed to determine if the user is at the corresponding location. This public media can be live video or audio captured by a public camera. In some approaches motion or gesture based authentication or comparison can be used. For example, the user moves the first computing device 380 in a certain way. Sensors on the device capture the motion of the device and transmit this information to authentication service which then takes the information and compares with information captured by one of the other devices, or with a predefined set of motions that the user has stored as a motion key.

Once the user has authenticated to the various devices the user can use the devices as normal without further log-in or authentication being required. However, in some approaches the system employs automatic de-authentication. The automatic de-authentication is performed by monitoring the conditions around the user and the machines. If the conditions can no longer be met the system will automatically log the user out of or lock the devices. The monitoring of the condition is illustrated at step 560. This monitoring is typically repeating the process of one of the authentication paths discussed above. For example, the system monitors the ambient sound around the devices. If the ambient sounds around the devices no longer match the system can cause the de-authentication to occur. In some approaches, such as where authentication was based on the active involvement of the user, the system may cause one of the devices to prompt the user to capture the image on the screen and the comparison of authentication path 503 can be repeated. So long as there is a match between the devices the authentication remains valid for all of the machines. If not the de-authentication occurs at step 570.

In overview, the present disclosure is directed to a system and method for providing enhanced multifactor authentication of a user to multiple different computing devices based on their prior authentication to a first computing device. Disclosed is a method for authenticating a user with a computing device. The first step in the method is to authenticate the user with a first computing device. Next the user brings the first computing device in proximity to a second computing device. Then the method authenticates the user with the second computing device based at least in part on the user's authentication with the first computing device and the proximity of the first computing device to the second computing device. This authentication can also include the authentication of the user with a third computing device based at least in part on the user's authentication with the first computing device and the user's authentication with the second computing device. The authentication process involves the first computing device or the second computing device recording something that is either common to both devices or transmitted from one of the devices to the other device. Based on a comparison of the transmission/recording the proximity of the devices can be determined. In some approaches the method further monitors the proximity of the first computing device with the second computing device following authentication of the user with the second computing device, and de-authenticates the user from the second computing device when the first computing device is no longer proximate to the second computing device. This can occur because the user has left the room where the devices are located.

Also disclosed is a system for authenticating a user to a computing device. The system includes at least a first computing device, a second computing device and an authentication service. The first computing device requires that the user to authenticate with the first computing device to use the first computing device. Similarly, the second computing device requires the user to authenticate with the second computing device to use the second computing device. The second computing device and the first computing device are configured to communicate information between each other when the first computing device and the second computing device are proximate to each other. This information may be for example a common recording of ambient sound and/or a transmission from one of the devices to the other device. The system also includes the authentication service that is configured to authenticate the user with the first computing device and to authenticate the user to at least the second computing device based on a determined proximity of the first computing device to the second computing device and the user's authentication to the first computing device. The authentication service may be a component or embodied on an authentication server which may be remote from the computing devices.

1. A method for authenticating a user with a computing device, the method comprising:
authenticating the user with a first computing device;
bringing the first computing device in proximity to a second computing device; and
authenticating the user with the second computing device based at least in part on the user's authentication with the first computing device and the proximity of the first computing device to the second computing device.

2. The method of claim 1 further comprising:
authenticating the user with a third computing device based at least in part on the user's authentication with the first computing device and the user's authentication with the second computing device.

3. The method of claim 1 further comprising:
monitoring the proximity of the first computing device with the second computing device following authentication of the user with the second computing device; and
de-authenticating the user from the second computing device when the first computing device is no longer proximate to the second computing device.

4. The method of claim 1 wherein authenticating the user with the second computing device further comprises:
activating a first microphone associated with the first computing device and a second microphone associated with the second computing device;
recording with the first microphone a first recording of ambient sound;
recoding with the second microphone a second recording of ambient sound;
providing the first recording and the second recording to an authentication service;
comparing the first recording with the second recording to determine if the recordings are recordings of similar ambient sound; and
authenticating the user with the second computing device when the recordings are determined to be similar.

5. The method of claim 4 wherein authentication the user with the second computing device further comprises:
determining if the user is permitted to access the second computing device;
giving the user access to the second computing device when the user is permitted to access the second computing device; and
denying the user access to the second computing device when they are not permitted to access the second computing device.

6. The method of claim 1 wherein authenticating the user with the second computing device further comprises:
activating a microphone associated with the second computing device;
transmitting a sound from the first computing device;
recording the transmitted sound at the second computing device as a recording;
providing an authentication service with the recording from the second computing device and the transmission from the first computing device;
comparing the recording with the transmission to determine if the recording is a recording of the transmission; and
authenticating the user with the second computing device when the recording is determined to be a recording of the transmission.

7. The method of claim 6 wherein the transmission is a sound that is not audible to a human.

8. The method of claim 6 wherein the transmission is automatically performed when the first computing device is determined to be proximate to the second computing device.

9. The method of claim 1 wherein authenticating the user with the second computing device further comprises:
activating a camera component on the first computing device;
activating an image projection component on the second computing device;
displaying an image by the image projection component;
capturing the displayed image with the camera component;
transmitting the captured image and the displayed image to an authentication service;
comparing the captured image with the displayed image to determine if the captured image matches the displayed image; and
authenticating the user with the second computing devices when the captured image matches the displayed image.

10. The method of claim 9 wherein the displayed image is not visible to a human.

11. The method of claim 9 wherein the displayed image is a moving image.

12. The method of claim 9 wherein the image projection component is a light feature and the displayed image is a light pattern.

13. The method of claim 9 wherein the displayed image includes a digital fingerprint.

14. A system for authenticating a user to a computing device, the system comprising:
a first computing device, the first computing to require the user to authenticate with the first computing device to use the first computing device;
a second computing device, the second computing device configured to require the user to authenticate with the second computing device to use the second computing device, wherein the second computing device and the first computing device are configured to communicate information between each other when the first computing device and the second computing device are proximate to each other; and
an authentication service, the authentication service configured to authenticate the user with the first computing device and to authenticate the user to at least the second computing device based on a determined proximity of the first computing device to the second computing device and the user's authentication to the first computing device.

15. The system of claim 14 wherein the first computing device and the second computing device are configured to record ambient sound as a first recording and a second recording respectively; and
wherein the authentication service is configured to compare the first recording with the second recording to determine if the first computing device and the second computing device are proximate to each other.

16. The system of claim 14 further comprising:
the first computing device is further configured to produce a sound;
the second computing device is further configured to record the sound produced by the first computing device as a recording; and
the authentication service is further configured to receive a copy of the sound from the first computing device, the recording recorded by the second computing device, and compare the sound with the recording to determine if they match thereby determining that the first computing device and the second computing device are proximate to each other.

17. The system of claim 14 further comprising:
the first computing device is further configured to capture an image having a digital signature;
the second computing device is further configured to display the image such that the first computing device can capture the image; and
the authentication is further configured to receive the captured image from the first computing device and the displayed image from the second computing device and to compare the captured image with the displayed image to determine if they match, thereby determining that the first computing device and the second computing device are proximate to each other.

18. The system of claim 14 further comprising:
a third computing device, the third computing device known to be proximate to the second computing device; and
wherein the authentication service authenticates the user to the third computing device as a result of authenticating the user to the second computing device.

19. The system of claim 14 wherein the authentication service is further configured to de-authenticate the user from the second computing device when the authentication service determines that the first computing device is no longer proximate to the second computing device.

20. A method for authenticating a user with a computing device, the method comprising:
authenticating the user with a first computing device;
bringing the first computing device in proximity to a second computing device;
authenticating the user with the second computing device based at least in part on the user's authentication with the first computing device and the proximity of the first computing device to the second computing device;
determining if the user is permitted to access the second computing device;
giving the user access to the second computing device when the user is permitted to access the second computing device; and
denying the user access to the second computing device when they are not permitted to access the second computing device.
